(19) United States
(12) Patent Application Publication
(10) Pub. No.: US 2013/0061457 A1
(43) Pub. Date: Mar. 14, 2013

(54) METHOD OF FORMING A ROTOR LAMINATION ASSEMBLY

(71) Applicant: Remy Technologies, L.L.C., Pendleton, IN (US)

(72) Inventors: Bradley D. Chamberlin, Pendleton, IN (US); David A. Fulton, Anderson, IN (US)

(73) Assignee: REMY TECHNOLOGIES, L.L.C., Pendleton, IN (US)

(21) Appl. No.: 13/672,191

(22) Filed: Nov. 8, 2012

Related U.S. Application Data
(62) Division of application No. 12/953,025, filed on Nov. 23, 2010.

(51) Int. Cl. H02K 15/02

(52) U.S. Cl. 29/598

(57) ABSTRACT

A method of forming a rotor lamination assembly for an electric machine includes aligning a plurality of laminations to form a rotor lamination assembly. The rotor lamination assembly includes an outer diametric surface. The method also includes mounting a rotor lamination compression sleeve to the outer diametric surface of the rotor lamination assembly. The rotor lamination compression sleeve radially compresses the plurality of laminations.

### CROSS-REFERENCE TO RELATED APPLICATION

This application is a divisional of U.S. application Ser. No. 12/953,025, filed Nov. 23, 2010, the disclosure of which is incorporated by reference herein in its entirety.

### BACKGROUND OF THE INVENTION

Exemplary embodiments pertain to the art of electric machines and, more particularly, to an electric machine including a rotor lamination assembly having a rotor lamination compression sleeve.

Electric machines include a rotor that rotates relative to a stator. Electrical current passing though the stator is influenced by a magnetic field developed in the rotor creating an electro-motive force that causes the rotor to spin. Certain electric motors/generators employ permanent magnets in the rotor. The permanent magnets are mounted in magnet slots formed in the rotor which is typically constructed from a plurality of stacked laminations. Generally, the permanent magnets are mounted near an outside edge of the rotor, as close to the outside edge as possible, in order to maximize torque and minimize flux losses. Mounting the permanent magnets in this manner creates a thin bridge area between the magnet slots and the outside edge of the rotor lamination.

During high speed operation, centrifugal forces on the rotor create stresses in the thin bridge area. If operated at too high a speed, the stress can exceed a yield strength of the laminations. In such a case, the rotor will fail. Accordingly, there exists a trade off between maximizing torque and operating the electric machine at high speed. Maximizing torque by mounting the permanent magnets as close to the outside edge of the rotor limits the overall operational speed of the electrical machine.

### BRIEF DESCRIPTION OF THE INVENTION

Disclosed is a method of forming a rotor lamination assembly for an electric machine. The method includes aligning a plurality of laminations to form a rotor lamination assembly. The rotor lamination assembly includes an outer diametric surface. The method also includes mounting a rotor lamination compression sleeve to the outer diametric surface of the rotor lamination assembly. The rotor lamination compression sleeve radially compresses the plurality of laminations.

Further disclosed is a method of forming a rotor lamination assembly for an electric machine. The method includes aligning a plurality of laminations to form the rotor lamination assembly, and compressing the plurality of rotor laminations with a rotor lamination compression sleeve.

### BRIEF DESCRIPTION OF THE DRAWINGS

The following descriptions should not be considered limiting in any way. With reference to the accompanying drawings, like elements are numbered alike:

FIG. 1 is a partial, cross-sectional view of an electric machine including a rotor lamination assembly having a rotor lamination compression sleeve;

FIG. 2 is a plan view of a rotor lamination assembly in accordance with one aspect of the exemplary embodiment provided with the rotor lamination compression sleeve of FIG. 1;

FIG. 3 is a perspective view of the rotor lamination compression sleeve of FIG. 1 in accordance with an exemplary embodiment; and

FIG. 4 is a plan view of a rotor lamination assembly in accordance with another aspect of the exemplary embodiment provided with the rotor lamination compression sleeve of FIG. 1.

### DETAILED DESCRIPTION OF THE INVENTION

A detailed description of one or more embodiments of the disclosed apparatus and method are presented herein by way of exemplification and not limitation with reference to the Figures.

Exemplary embodiments provide sleeve member that structurally supports high stress regions of a rotor lamination assembly. The sleeve member extends about and compresses the rotor lamination assembly to support tensile stresses that develop in rotor lamination edge regions. By supporting the edge regions of the rotor laminations, an electric machine may be operated at higher output speeds without subjecting the rotor to high stresses that may lead to premature rotor failure.

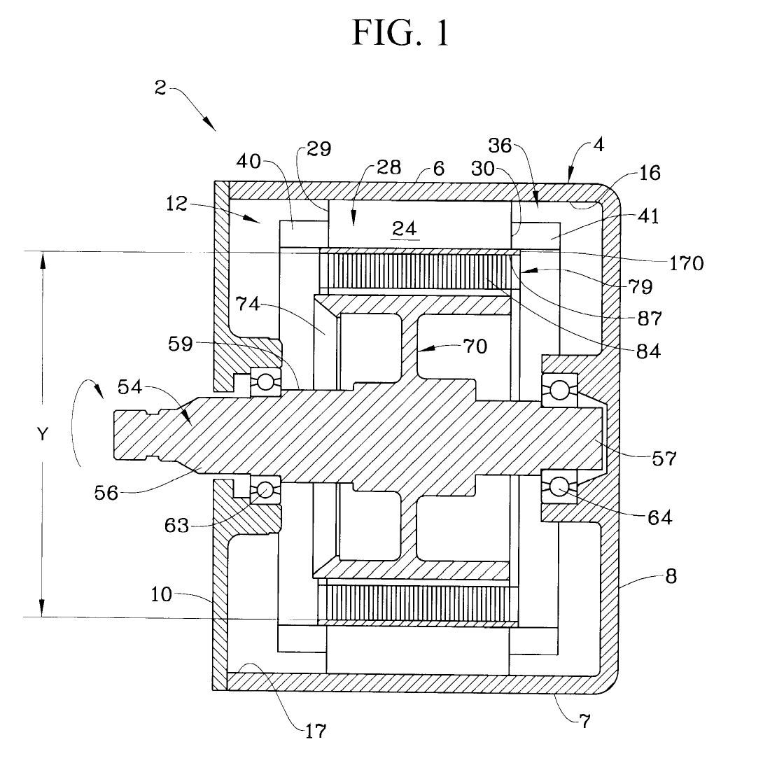

An electric machine is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes an inner surface 16 and second side wall 7 includes an inner surface 17. At this point it should be understood that housing 4 could also be formed to include a single side wall having a continuous inner surface. Electric machine 2 is further shown to include a stator 24 arranged at inner surfaces 16 and 17 of first and second side walls 6 and 7. Stator 24 includes a body 28 having a first end portion 29 that extends to a second end portion 30 and supports a plurality of windings 36. Windings 36 include a first end turn portion 40 and a second end turn portion 41.

Electric machine 2 is shown to include a shaft 54 rotatably supported within housing 4. Shaft 54 includes a first end 56 that extends to a second end 57 through an intermediate portion 59. First end 56 is rotatably supported relative to second end wall 10 through a first bearing 63 and second end 57 is rotatably supported relative to first end wall 8 through a second bearing 64. Shaft 54 supports a rotor 70 that is rotatably mounted within housing 4. Rotor 70 includes a hub 74 that is fixed relative to intermediate portion 59 and a rotor lamination assembly 79. Rotor lamination assembly 79 includes a plurality of laminations, one of which is indicated at 84. Laminations 84 are stacked and aligned to define an outer diametric surface 87 of rotor lamination assembly 79. At this point it should be understood that electric machine 2 could also be configured with a rotor rotatably supported to a central shaft by bearings.

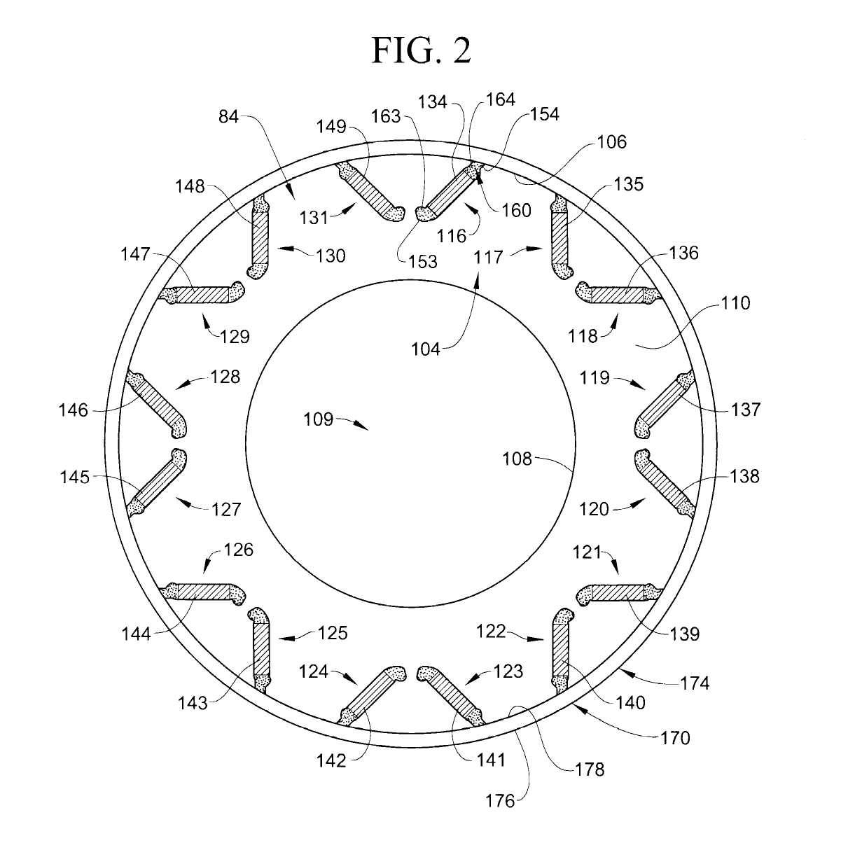

As best shown in FIG. 2, lamination 84 includes a body member 104 having an outer diametric edge 106 and an inner diametric edge 108 that defines a central opening 109. Lamination 84 includes a radial web 110 that extends between outer and inner diametric edges 106 and 108. A plurality of magnet receiving members 116-131 are formed in radial web 110 and extend about lamination 84. Magnet receiving members 116-131 are configured to receive a corresponding plurality of magnets 134-149. Magnets 134-149 are rotated relative to stator 24 to generate an electro-motive force in windings 36. As each magnet receiving member 116-131 is similarly constructed, a detailed description will follow referencing magnet receiving member 116 with an understanding that the remaining magnet receiving members 117-131 are similarly constructed. Magnet receiving member 116 includes a first end section 153 that extends to a second end section 154. Second end section 154 defines an interruption zone 160 at outer diametric edge 106. A first filler 163 is arranged between first end section 153 and magnet 134 and a second filler 164 is arranged between second end section 154 and magnet 134. First and second fillers 163 and 164 support and/or retain magnet 134 within magnetic receiving member 116. At this point it should be understood that the above-described structure is provided for illustrative purposes and should not be considered as limiting to the exemplary embodiment which is directed to a rotor lamination compression sleeve 170 positioned upon outer diametric surface 87 of rotor lamination assembly 79.

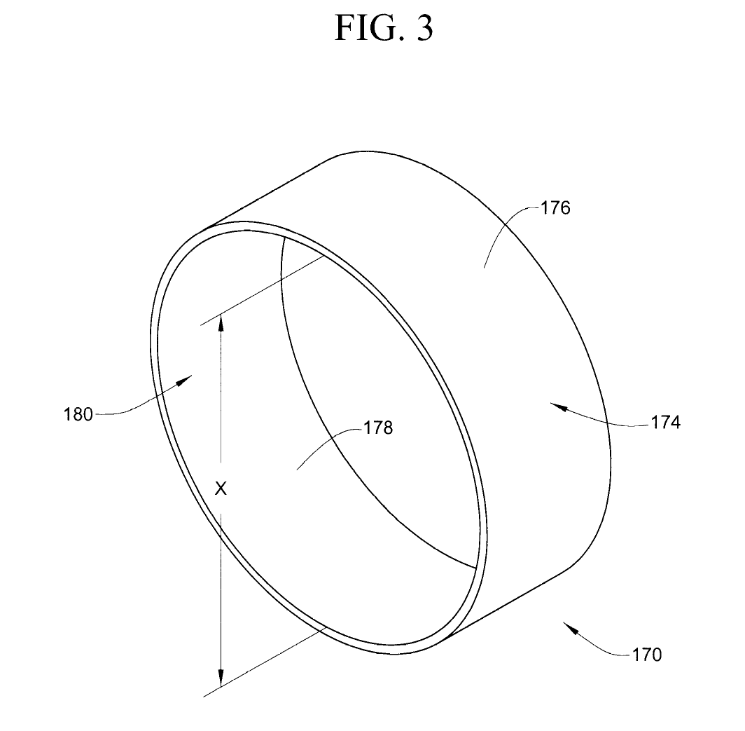

In accordance with an exemplary embodiment illustrated in FIG. 3, rotor lamination compression sleeve 170 includes a body member 174 having an outer diametric surface 176 and an inner diametric surface 178 that defines an annular ring 180. At rest, inner diametric surface 178 defines a first diameter “X” of rotor lamination compression sleeve 170. As will be discussed more fully below, rotor lamination compression sleeve 170 is formed from a material, such as austenitic nickel-chromium alloys, other high strength alloys, steels and the like, that expands to a second diameter “Y” of rotor 70. The first diameter “X” of rotor lamination compression sleeve 170 is sized to provide a radial compressive force to rotor lamination assembly 79 when rotor 70 is at rest. That is, in a free state, rotor lamination compression sleeve 170 includes an inner diameter that is smaller than an outer diameter of the plurality of laminations 84. The smaller, free-state, diameter generates a pre-load on the plurality of laminations 84. More specifically, at rest, rotor lamination compression sleeve 170 is in tension and the plurality of laminations 84 experience a radial compressive force. The radial compressive force supports the outer diametric edge 106 of each of the plurality of laminations 84. With this arrangement, an increase of tensile stress at outer diametric edge 106, or in a bridge area (not separately labeled) between adjacent magnet receiving members 116-131 is supported by rotor lamination compression sleeve 170. Supporting outer diametric edge 106 and/or the bridge area enhances operating characteristics of electric machine 2. That is, reducing tensile stress allows electric machine 2 to operate at higher speed levels.

In further accordance with an exemplary embodiment, when rotor 70 begins to experience centrifugal forces rotor lamination compression sleeve 170 gradually expands reducing the first radial compressive force. That is, centrifugal forces cause rotor lamination compression sleeve 170 to gradually expand thereby reducing the first radial compressive force to a second, lower radial compressive force. As the radial compressive force is reduced, tensile stresses in rotor lamination assembly 79 increase. However, while the first radial compressive force decreases, the second radial compressive force still provides external support such that the tensile stresses remain below a critical tensile stress that would lead to rotor failure. At this point it should be understood that while rotor lamination compression sleeve 170 creates a larger air gap between an outer diameter of rotor 70 and an inner diameter of the stator 24 that may reduce performance, any reduction in performance is off-set by the reduction in tensile stresses and an increased overall operational envelope.

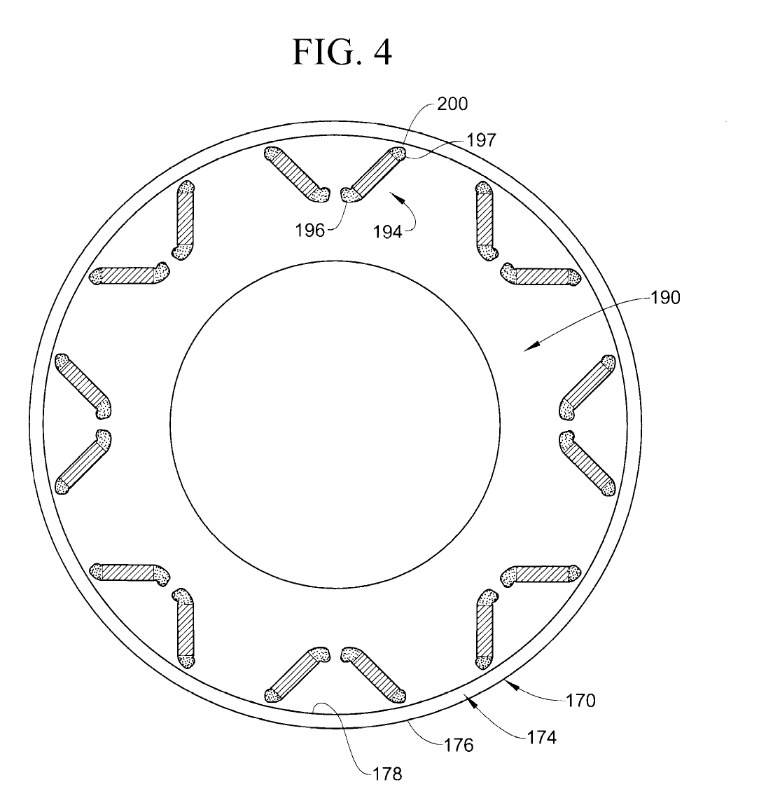

In addition to rotor laminations having open magnet receiving members, rotor lamination compression sleeve 170 may be employed with a wide range of rotor laminations including partially open (not shown) and closed laminations such as shown at 190 in FIG. 4 wherein like reference numbers represent corresponding parts in the respective views. Lamination 190 includes a plurality of magnet receiving members, one of which is indicated at 194. Magnet receiving member 194 includes a first end section 196 that extends to a second end section 197. Second end section 197 is closed thereby defining a bridge region 200. Bridge region 200 is supported by rotor lamination compression sleeve 170. In this manner, lamination 190 is more resistant to tensile stresses developed during operation and electric machine 2 is operable at a higher speed ranges than those previously attainable.

At this point it should be understood that the exemplary embodiments describe a rotor lamination compression sleeve that structurally supports a rotor lamination assembly during operation. The structural support provided to the rotor lamination assembly enables each lamination to better withstand tensile stresses that are developed during operation, particularly, at high speed. In this manner, the rotor lamination compression sleeve enhances an overall operational envelope of the electric machine.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A method of forming a rotor lamination assembly for an electric machine, the method comprising:
aligning a plurality of laminations to form the rotor lamination assembly, the rotor lamination assembly including an outer diametric surface; and
mounting a rotor lamination compression sleeve to the outer diametric surface of the rotor lamination assembly, the rotor lamination compression sleeve radially compressing the plurality of laminations.

2. The method of claim 1, further comprising: bridging an interruption zone formed in an outer diametric edge of at least one of the plurality of laminations with the rotor lamination compression sleeve.

3. The method of claim 1, further comprising: forming the rotor lamination compression sleeve from austenitic nickel-chromium alloy.

4. The method of claim 1, wherein mounting the rotor lamination compression sleeve includes mounting the rotor lamination compression sleeve in a free state wherein the rotor lamination compression sleeve includes an inner diameter having a first dimension that is smaller than the outer diametric surface of the plurality of laminations.

5. The method of claim 1, further comprising: rotating the rotor lamination assembly causing the inner diameter to expand to a second dimension that is greater than the first dimension but still smaller than the outer diametric surface of the plurality of laminations.

6. The method of claim 1, further comprising: supporting a bridge region of a magnet receiving member with the rotor lamination compression sleeve.

7. A method of forming a rotor lamination assembly for an electric machine, the method comprising:
aligning a plurality of laminations to form the rotor lamination assembly; and
compressing the plurality of rotor laminations with a rotor lamination compression sleeve.

8. The method of claim 7, wherein compressing the plurality of rotor laminations comprises radially compressing the plurality of rotor laminations.

9. The method of claim 7, further comprising: bridging an interruption zone formed in an outer diametric edge of at least one of the plurality of laminations with the rotor lamination compression sleeve.

10. The method of claim 7, further comprising: supporting a bridge region of a magnet receiving member with the rotor lamination compression sleeve.

11. The method of claim 7, wherein compressing the plurality of rotor laminations include compressing the plurality of rotor laminations with a first compressive force.

12. The method of claim 11, further comprising: rotating the rotor lamination assembly causing a reduction in the first compressive force.
